(19) United States
(12) Patent Application Publication
(10) Pub. No.: US 2010/0284647 A1
(43) Pub. Date: Nov. 11, 2010

(54) Optical ribbon cable attachment mechanism for the backside of a circuit board

(75) Inventor: Daniel S. Stevenson, (US)

Correspondence Address: Imperium Patent Works LLP, P.O. Box 587, Sunol, CA, 94586, US

(73) Assignee: siXis, Inc.

(21) Appl. No.: 12/387,874

(22) Filed: May 9, 2009

(51) Int. Cl. G02B 6/12; G02B 6/00; G02B 6/32

(52) U.S. Cl. 385/14; 385/137; 385/33

(57) ABSTRACT

A low-profile, mass-producible, unitary injection molded optical ribbon attachment structure includes a ribbon retaining portion, a light reflecting portion, and a plurality of lens portions. An end portion of a fiber optic ribbon cable is disposed in a ribbon retaining groove in the ribbon retaining portion. The unitary structure is fixed onto a bottom major surface of a circuit board. In a transmit application, light emitted from an optoelectronic component disposed on a top major surface of the circuit board passes down through a hole or slit in the circuit board, into one of the lens portions, then reflects off a planar light reflecting surface of the light reflecting portion and is redirected approximately ninety degrees, and then passes substantially parallel to the bottom major surface of the circuit board and enters the end of the fiber optic ribbon cable. In a receive example, light passes the opposite direction.

### TECHNICAL FIELD

The described embodiments relate to coupling and connection of fiber optic components to circuit boards and optoelectronic components.

### BACKGROUND INFORMATION

The Optical fibers are often used to communicate information. In one example, information is initially carried in an electrical signal. This electrical signal is then converted by a suitable transducer into an optical signal that also carries the information. The optical signal, which is referred to here as “light” (even though it may not actually be of a wavelength of visible light), passes through the optical fiber to a second transducer. The second transducer converts the optical signal back into an electrical signal that carries the information. A circuit, such as a high-speed digital integrated circuit, can then receive the electrical signal and the information. Packaged transducers in the form of Photonic Integrated Circuits (PICs) are typically used to perform the required optical to electrical conversions. Unfortunately, these devices may occupy an undesirably large amount of space on a circuit board. Also, they frequently use surface emitting/detecting optical transmitters/receivers due to their lower cost relative to edge emitting devices. PICs using these devices are relatively tall in comparison to their footprint, rendering them unsuitable for high density electronics designs such as vertically stacked PCBs and SiCBs. For these designs, direct integration of unpackaged transducer components into the SiCB or PCB design can result in substantially denser overall system designs. However assembly of optical components can be labor intensive, due to the need for manual mechanical alignment techniques.

Accordingly, an inexpensive, easy and space-efficient way to couple optical fibers to circuitry on a circuit board is desired. The preferred method should involve self aligning optical components, low height (<1 mm), small footprint, self aligning optical and surface emitting opto-electronic components, and flip chip bump bonded assembly and reflow furnace processing to avoid additional processing steps required to fabricate planar waveguide structures. Maximizing the use of direct coupling of optical devices to avoid the use of planar waveguides which required additional process steps, and avoid the use of temperature sensitive optical components. The physical connection of the fiber to the transducer may be bulky, and may involve additional intermediary bulky components such connectors and lenses. Accordingly, an inexpensive, and easy and space-efficient way to couple optical fibers to circuitry on a circuit board is desired.

### SUMMARY

A low-profile, mass-producible, unitary injection molded optical ribbon attachment structure includes a fiber optic ribbon retaining portion, a light reflecting portion, and a plurality of lens portions. In an assembly, an end portion of a fiber optic ribbon cable is disposed in a ribbon retaining groove in the fiber optic ribbon retaining portion. The unitary structure is disposed on a bottom major surface of a circuit board. The unitary structure is fixed in place to the circuit board using a press-fit and adhesiveless attachment mechanism. An optoelectronic component is disposed on a top major surface of the circuit board opposite the unitary structure.

In a transmit application, light emitted from the optdelectronic component (for example, a VCSEL array) passes down through a hole or slit in the circuit board and into one of the lens portions of the unitary structure. The lens portion is located in the hole or slit. The light passes through the lens portion, then reflects off a planar light reflecting surface of the light reflecting portion thereby being redirected approximately ninety degrees. The redirected light then passes substantially parallel to the bottom major surface of the circuit board and exits the unitary structure. Then light then enters the end of the fiber optic ribbon cable.

In a receive application, light passes in the opposite direction. The light is output from the end of the fiber optic ribbon cable, passes in a direction substantially parallel to the bottom major surface of the circuit board to the planar light reflecting surface and is redirected approximately ninety degrees, and then passes vertically up through the lens portion and to the optoelectronic component (for example, a PIN diode array) disposed on the top major surface of the circuit board.

Further details and embodiments and methods are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a perspective exploded view of an assembly usable to couple a fiber optic ribbon cable to a circuit board so that there can be optical communication between the fiber optic ribbon cable on one side of the circuit board and an optoelectronic component on an opposite side of the circuit board. Optical communication occurs via a lens disposed in a hole or slit in the circuit board.

FIG. 2 is a perspective view that shows the component portions of the unitary injection molded optical ribbon attachment structure 5 of the assembly of FIG. 1.

FIG. 3 is a cross-sectional view of the assembly of FIG. 1 when the unitary structure 5 is attached to the bottom major surface of a circuit board. The end portion of the fiber optic ribbon cable is sandwiched between a cap 6 and the unitary structure 5.

FIG. 4 is a cross-sectional view of the assembly of FIG. 1 showing various axes and planes.

FIG. 5 is a cross-sectional view of the assembly of FIG. 1 showing how an adhesiveless press-fit attachment mechanism secures the unitary structure 5 of FIG. 1 to the bottom major surface 34 of the circuit board.

FIG. 6 is a flowchart of a method in accordance with one novel aspect.

### DETAILED DESCRIPTION

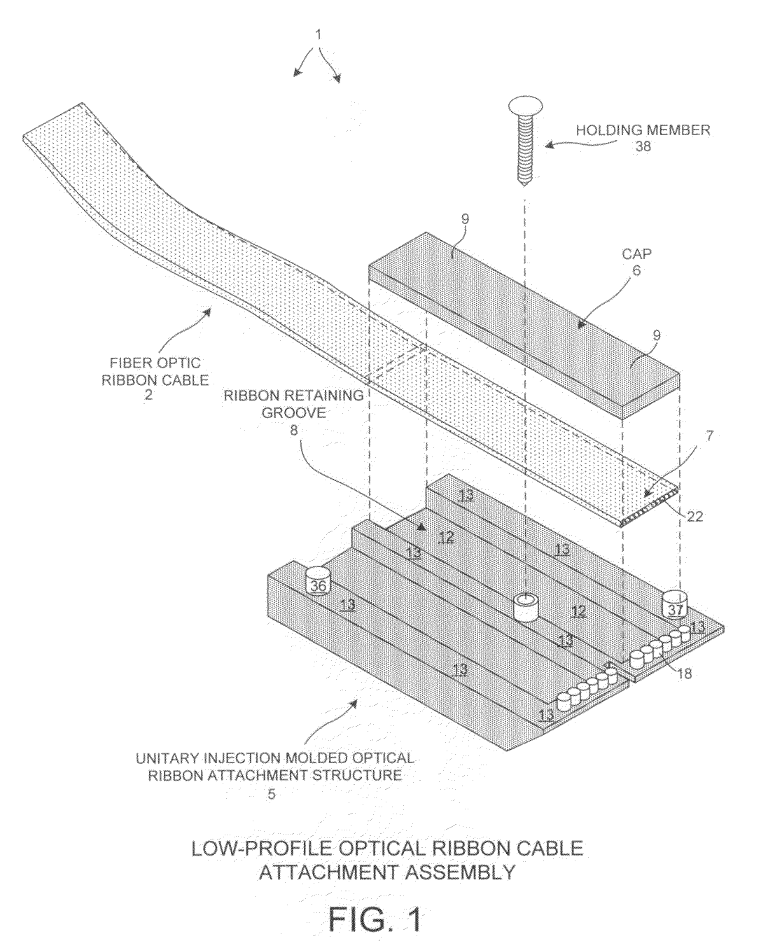

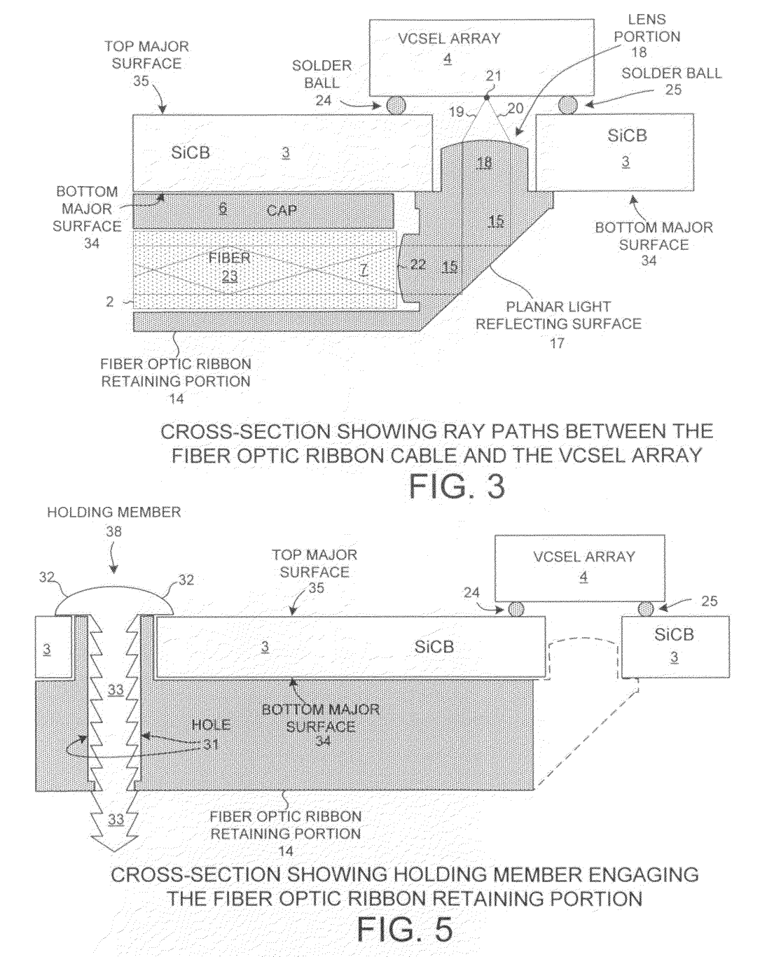

FIG. 1 is a simplified perspective exploded view of an assembly 1 usable to couple a fiber optic ribbon cable 2 to a circuit board so that there can be optical communication between the fiber optic ribbon cable on one side of the circuit board and an optoelectronic component on an opposite side of the circuit board. Fiber optic ribbon cable 2 includes a plurality of multi-mode fibers. The circuit board is not shown in the view of FIG. 1 so that other details of the assembly will not be obscured. The circuit board is illustrated in cross-section in FIGS. 3-5 and is identified by reference numeral 2. In the specific embodiment illustrated, circuit board 2 is a semiconductor substrate also referred to as a silicon circuit board or “SiCB.” The optoelectronic component is also not shown in the view of FIG. 1, but rather is illustrated in FIGS. 3-5 and is identified by reference numeral 3. The optical communication can be in the direction from fiber optic ribbon cable 2 to the optoelectronic component 3 and/or from the optoelectronic component 3 to fiber optic ribbon cable 2.

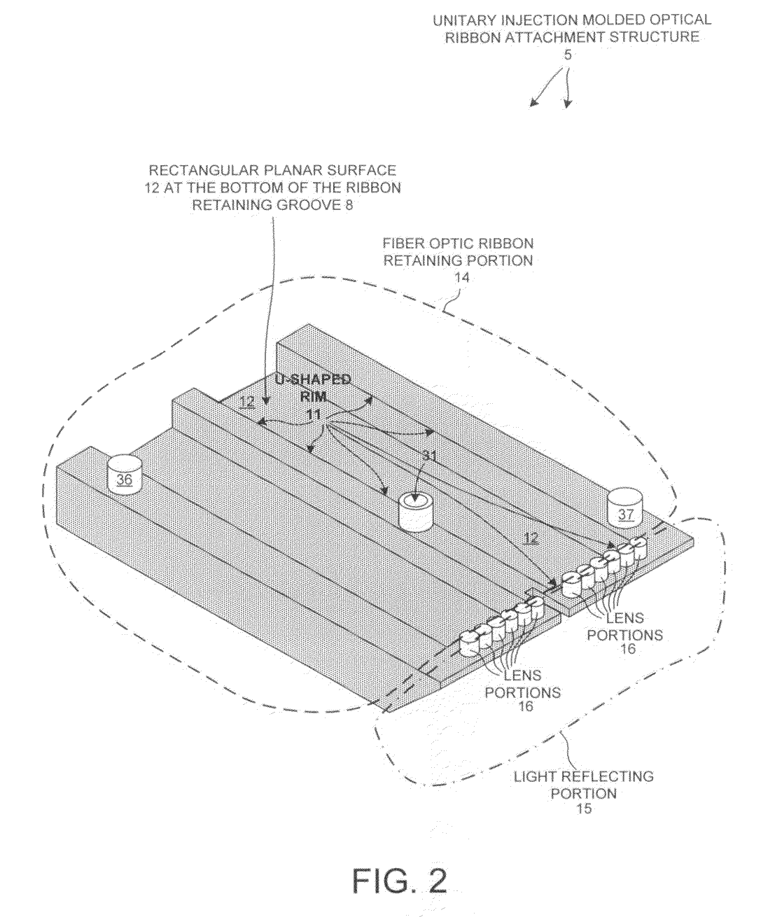

Assembly 1 includes a unitary injection molded optical ribbon attachment structure 5, the fiber optic ribbon cable 2, a cap 6 that is also an injection molded structure, and a holding member 38. An end portion 7 of fiber optic ribbon cable 2 is disposed in an accommodating and similarly shaped ribbon retaining groove 8 of unitary structure 5. The bottom surface 12 of groove 8 in the illustrated embodiment is planar and has a rectangular shape. The width of groove 8 is slightly wider than the width of cable 2 as illustrated. The cap 6 is of the width and length of the groove, and is disposed on top of cable 2 in the groove such that a top surface 9 of cap 6 is flush with a U-shaped rim 11 (see FIG. 2) that surrounds groove 8. U-shaped rim 11 surrounds groove 8 on three sides as illustrated. End portion 7 of cable 2 is sandwiched between the bottom surface of groove 8 and cap 6 and is held in place there by pressure between the cap and unitary structure 5. Assembly 1 is fixed to the bottom major surface of circuit board 2 such that a circuit board engaging surface 13 and the top surface 9 of cap 6 fit up and against the bottom major surface of the circuit board.

FIG. 2 is a perspective view that shows the component portions of unitary injection molded optical ribbon attachment structure 5. Unitary structure 5 includes a fiber optic ribbon retaining portion 14, a light reflecting portion 15, and a plurality 16 of identically shaped lens portions. In the illustrated embodiment, the lens portions are disposed in a row and extend upward from the plane of circuit board engaging surface 13. Each lens portion has a convex upper surface. Unitary structure 5 may be made of any suitable injection molded translucent plastic material such as, for example, optical grade acrylic, polystyrene, or polycarbonate.

FIG. 3 is a cross-sectional view of assembly 1 of FIG. 1 when the assembly is attached to the bottom major surface 34 of circuit board 3. As illustrated, light reflecting portion 15 has a substantially planar light reflecting surface 17 (also referred to as a prism). One lens portion 18 of the plurality 16 of lens portions of FIG. 1 is pictured in cross-section in FIG. 2. Lens portion 18 is disposed in an accommodating hole or slot in circuit board 3. Fiber optic ribbon retaining portion 14 and cap 6 together hold the end portion 7 of ribbon cable 2 as pictured with respect to planar light reflecting surface 17. Reference numeral 23 identifies one fiber of ribbon cable 2.

In the illustrated embodiment, optoelectronic component 4 is a surface-mounted or bump-bonded VCSEL (Vertical-Cavity Surface-Emitting Laser) array transducer integrated circuit. The use of bump-bonding and careful metal layout design, assures a high degree of self alignment between the VCSEL and the PCB/SiCB during the reflow process due to the surface tension of molten solder balls. VCSEL array 4 is a transducer that converts an electrical signal into an optical signal. The optical signal is referred to here generally and colloquially as “light” even though it is understood that the wavelength of the radiation of the optical signal may actually be out of the visible spectrum. The “light” of the optical signal may be, and typically is, infrared radiation. Lines 19 and 20 in FIG. 3 represent rays of this “light” that are emitted downward from a source location 21 on VCSEL array 4. Source location 21 is roughly located at the focal point of lens portion 18 on the lens axis of lens portion 18. The source location 21 is not a point source. The use of a point in the diagram is just for illustrative purposes. The focal length of lens portion 18 in this example is small and is less than five millimeters. The light emitted from VCSEL array 4 passes down into lens portion 18, passes through lens portion 18, reflects off the planar light reflecting surface 17 such that it is redirected approximately ninety degrees to the left, and then passes to the left and into the right end 22 of one fiber 23 of fiber optic ribbon cable 2. In this example, VCSEL array 4 is surface mounted to circuit board 3 by solder balls 24 and 25. VCSEL array 4 may be a packaged integrated circuit or a plurality of integrated circuits, or may be a bare integrated circuit die or dice. The plane of the bottom surface of VCSEL is typically less than one hundred microns away from the plane of the top major surface of the circuit board. This arrangement provides for a low height package and avoids the use of planar waveguide structures for interconnection of optical components.

The surface from which the light exits unitary structure 5 may or may not be convex and may or may not abut fiber 23. In the illustrated embodiment, the surface from which the light exits the unitary structure to the left is convex and does abut fiber 23. This surface may be considered to be a part of a single lens that also involves the convex upward-facing surface of lens portion 18. This overall lens that involves the two convex surfaces and the two associated lens portions includes an integrated prism in the form of planar light reflecting surface 17.

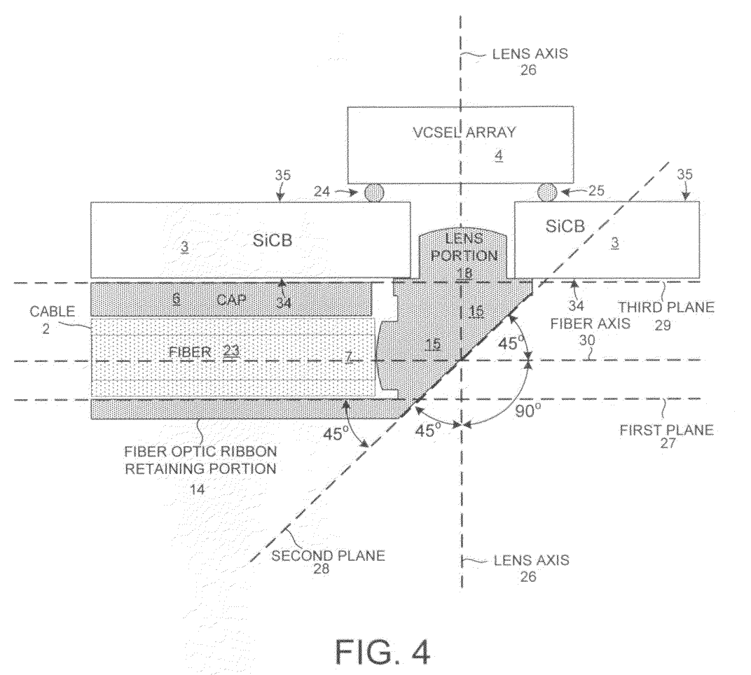

FIG. 4 illustrates the lens axis 26 of lens portion 18. Plane 27 (first plane) is the plane of the bottom surface 12 (see FIGS. 1 and 2) of ribbon retaining groove 8. Plane 28 (second plane) is the plane of the substantially planar light reflecting surface 17 of light reflecting portion 15. Plane 29 (third plane) is the plane in which the upward facing circuit board engaging surface 13 (see FIG. 1) of unitary structure 5 lies. The first and third planes 27 and 29 extend parallel to one another and parallel to the plane of the bottom major surface 34 of circuit board 3. Whereas lens portion 18 is disposed above the third plane 29 in the hole or slit in circuit board 3, planar light reflecting surface 17 is disposed below the third plane 29. Lens axis 26 intersects the second plane 28 at an angle of approximately forty-five degrees. The central axis 30 of fiber 23 also intersects the second plane 28 at an angle of approximately forty-five degrees. Lens axis 26 intersects the planar light reflecting surface at substantially the same point that the center axis 30 of the fiber intersects the planar light reflecting surface.

FIG. 5 is a cross-sectional diagram of assembly 1 taken along a cross-section that passes through holding member 38. Holding member 38 and the associated cylindrical hole 31 in fiber optic ribbon retaining portion 14 together constitute an adhesiveless press-fit attachment mechanism that secures the unitary structure 5 to the bottom of circuit board 3 without the use of any adhesive. In the illustrated example, holding member 38 is a pin that has a head portion 32 and a shaft portion 33. Shaft portion 33 has a plurality of concentric barbs. When the shaft portion is forced down into hole 31, the barbs engage the fiber optic ribbon retaining portion 14 thereby securing shaft portion 33 in hole 31 such that the head portion 32 of holding member 38 contacts the top major surface 35 of circuit board 3 and fixes the unitary structure 5 to circuit board 3. Alignment pegs 36 and 37 (see FIGS. 1 and 2) fit into registering associated indents in the bottom of circuit board 3 to prevent the unitary structure 5 from rotating with respect to the circuit board 3. More critically, they provide for a self alignment function between the unitary structure and the PCB/SiCB. The relative alignment of indents in the bottom of circuit board and the metal solder pads used for the VCSELs, assures mechanical self alignment between the unitary structure and the VCSEL array during assembly.

The press-fit and adhesiveless holding member 38 is but one type of attachment mechanism. Other suitable attachment mechanisms can be employed. For example, a barbed extension can be provided as part of unitary structure 5. The barbed extension extends upward from circuit board engaging surface 13. When unitary structure 5 is to be mounted to circuit board 3, the unitary structure 5 is moved toward the bottom major surface 34 of the circuit board such that the barbed extension is inserted into a hole in the circuit board thereby engaging the sides of the hole and a portion of the upper major surface 35 such that unitary structure 5 is fixed to the circuit board.

The unitary structure 5 of FIG. 1 can be used in a transmit application in which a transmit transducer emits light that is then directed into a fiber optic cable. The unitary structure 5 can also be used in a receive application in which light emitted from a fiber optic cable is directed to a receiver transducer. In the transmit application, the transducer may be a VCSEL array that receives light as described and illustrated above. In the receive application, the transducer may be PIN diode array that outputs light. Alternatively, some fibers of the fiber optic ribbon cable can be used in the receive application and others fibers can be used in the transmit application.

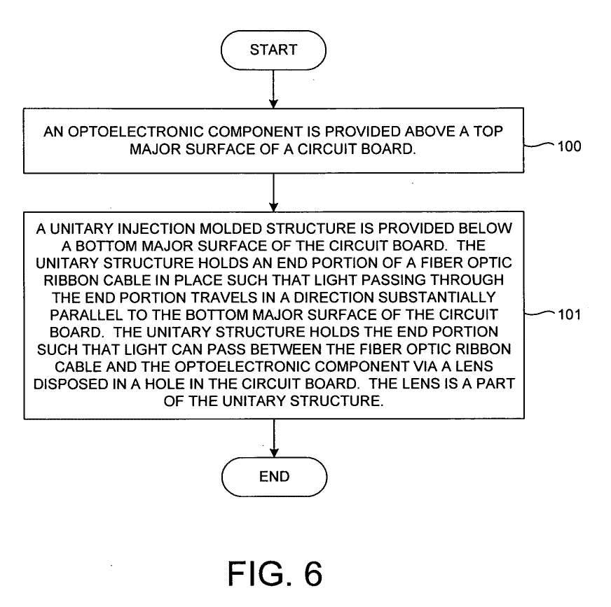

FIG. 6 is a simplified flowchart of a method in accordance with one novel aspect. An optoelectronic component is provided (step 100) above a top major surface of a circuit board. The top major surface can be surface 35 of FIG. 3. A unitary injection molded structure is provided (step 101) below a bottom major surface of the circuit board. The bottom major surface can be surface 34 of FIG. 3. The unitary structure holds an end portion of a fiber optic ribbon cable in place such that light passing through the end portion travels in a direction substantially parallel to the bottom major surface of the circuit board. The unitary structure holds the end portion so that light can pass between the fiber optic ribbon cable and the optoelectronic component via a lens. The lens has a lens axis that is perpendicular to the bottom major surface of the circuit board. The lens is disposed in a hole in the circuit board and is a part of the unitary injection molded structure. The lens can be lens portion 18 of FIG. 3.

The terms “top” and “bottom” are relative terms and are only used in this patent document to describe a relative relationship, in a non-limiting sense. Similarly, the terms “above” and “below” are relative terms and are only used herein to describe a relative relationship, in a non-limiting sense. It is to be understood that very same assembly of FIG. 3 can be considered from one vantage point in which the unitary structure 5 is disposed “below” the circuit board 3, and can also be considered from another vantage point in which the unitary structure 5 is disposed “above” the circuit board. What is the top major surface and what is the bottom major surface is therefore only a matter of the vantage point that is chosen to consider the assembly. The assembly and structures disclosed in this patent document can be considered equally well from any vantage point. The assembly can involve a circuit board having any orientation.

Although certain specific embodiments are described above for instructional purposes, the teachings of this patent document have general applicability and are not limited to the specific embodiments described above. Circuit board 3 need not be a semiconductor substrate or silicon circuit board, but rather may be another type of circuit board such as, for example, a Printed Circuit Board (PCB) involving FR4 fiberglass/resin. Although assembly 1 is explained above in connection with one fiber optic ribbon cable, a second fiber optic ribbon cable can also be part of the assembly. The second fiber optic ribbon cable engages the second ribbon retaining groove illustrated in the perspective view of FIG. 1. In one embodiment, there is no cap. Rather, unitary structure 5 has a slit into which the end portion of the fiber optic ribbon cable 2 is inserted. The slit is of the same approximate dimensions as the void left for accommodating the fiber optic ribbon cable 2 in the embodiment of FIG. 1 when the cap is in place. In some embodiments the depth of groove 8 is such that no cap is provided and so that the upper surface of the end portion of the cable 2 lies in the same plane as the U-shaped rim 11. The orientations of the two ribbon retaining grooves can be different such that one fiber optic ribbon cable extends into the unitary structure 5 from one side whereas the other fiber optic ribbon cable extends into the unitary structure 5 from the opposite side. The lenses need not extend into holes or slits in a circuit board as in the low-profile embodiment described above, but rather the lenses can be disposed below the bottom major surface of the circuit board. The unitary structure can be coupled to a clip member such that the end portion of an optical cable can be placed in a groove in the unitary structure and then the clip can be manipulated to press into and hold the end portion. The clip can thereafter be manipulated if desired to release the end portion of the cable so that the cable can be removed from the unitary structure. Unitary structure 5 is conveniently formed by injection molding, but the unitary structure 5 can also be formed in other ways such as by machining if desired. Accordingly, various modifications, adaptations, and combinations of various features of the described embodiments can be practiced without departing from the scope of the invention as set forth in the claims.

What is claimed is:

1. A unitary structure, comprising:
a fiber optic ribbon retaining portion that forms a ribbon retaining groove, wherein the ribbon retaining groove has a rectangular planar surface that extends in a first plane, wherein the fiber optic ribbon retaining portion is made of a translucent material;
a light reflecting portion that has a planar light reflecting surface, wherein the planar light reflecting surface is disposed in a second plane, and wherein the second plane meets the first plane at an angle of approximately forty-five degrees, wherein the light reflecting portion is made of the translucent material; and
a plurality of identically shaped lens portions, wherein one of the lens portions has a lens axis, wherein the lens axis meets the second plane at an angle of approximately forty-five degrees, and wherein the lens portions are also made of the translucent material.

2. The unitary structure of claim 1, wherein the unitary structure is a single injection molded structure that includes the fiber optic ribbon retaining portion, the light reflecting portion, and the plurality of lens portions.

3. The unitary structure of claim 2, wherein the fiber optic ribbon retaining portion defines a U-shaped rim that surrounds the groove on three sides, wherein the U-shaped rim is disposed in a third plane that is parallel to the first plane, wherein the light reflecting portion is disposed on one side of the third plane, and wherein the plurality of lens portions are disposed on an opposite side of the third plane.

4. The unitary structure of claim 3, wherein said one lens portion has a focal point disposed on the lens axis, and wherein the focal point is less than five millimeters away from said one lens portion.

5. The unitary structure of claim 4, wherein each of the lens portions has a convex surface.

6. The unitary structure of claim 3, wherein the fiber optic ribbon retaining portion forms a cylindrical hole, wherein the cylindrical hole has an axis, and wherein the axis of the cylindrical hole extends perpendicularly with respect to the first plane.

7. The unitary structure of claim 3, wherein the rectangular planar surface of the fiber optic ribbon retaining portion, the light reflecting portion, and the plurality of lens portions are disposed with respect to one another such that light passing into said one lens portion from a light source above the third plane is reflected off the planar light reflecting surface and then passes into an end of an optical fiber disposed the ribbon retaining groove.

8. The unitary structure of claim 3, wherein the rectangular planar surface of the fiber optic ribbon retaining portion, the light reflecting portion, and the plurality of lens portions are disposed with respect to one another such that light passing out of an optical fiber disposed in the ribbon retaining groove reflects off the planar light reflecting surface and then through said one lens portion and to a light destination above the third plane.

9. An assembly comprising:
a circuit board having a bottom major surface and a top major surface, wherein the circuit board is taken from the group consisting of a printed circuit board and a semiconductor circuit board;
an optoelectronic component disposed adjacent the top major surface of the circuit board;
a fiber optic ribbon that extends in a direction parallel to the bottom major surface of the circuit board so that light passing through the fiber optic ribbon also passes in the direction parallel to the bottom major surface of the circuit board; and
an optical ribbon attachment mechanism that is disposed adjacent the bottom major surface of the circuit board and is attached to the circuit board, wherein the optical ribbon attachment mechanism includes a fiber optic ribbon retaining portion that holds the fiber optic ribbon and engages an end portion of the fiber optic ribbon such that light emitted from the optoelectronic component passes into a lens portion of the attachment mechanism, reflects off a substantially planar light reflecting surface of a light reflecting portion of the attachment mechanism, and is redirected approximately ninety degrees to pass into the end portion of the fiber optic ribbon.

10. The assembly of claim 9, wherein the fiber optic ribbon retaining portion, the light reflecting portion, and the lens portion are parts of a single injection molded object formed of a translucent material.

11. The assembly of claim 10, wherein the lens portion is disposed at least in part in a hole in the circuit board.

12. The assembly of claim 11, wherein the optical ribbon attachment mechanism further comprises a holding member, wherein the fiber optic ribbon retaining portion is largely disposed below the bottom major surface the circuit board, and wherein the holding member engages a portion of the top major surface of the circuit board and extends through a hole in the circuit board and engages the fiber optic ribbon retaining portion thereby fixing the fiber optic ribbon retaining portion to the circuit board.

13. A method comprising:
providing an optoelectronic component above a top major surface of a circuit board; and
providing a fiber optic ribbon cable below a bottom major surface of the circuit board using a unitary injection molded structure such that light can pass between the fiber optic ribbon cable and the optoelectronic component through a hole in the circuit board, wherein the unitary structure engages an end portion of the fiber optic ribbon cable such that a center axis of a fiber of the fiber optic ribbon cable extends in a direction parallel to the bottom major surface of the circuit board, wherein the unitary structure has a planar light reflecting surface disposed in a plane that intersects the center axis at approximately a forty five degree angle, wherein the unitary structure further includes a lens portion having a lens axis that is substantially perpendicular to the bottom major surface of the circuit board, wherein the lens axis intersects the planar light reflecting surface at substantially the same point that the center axis of the fiber intersects the planar light reflecting surface.

14. The method of claim 13, further comprising:
using a holding member to hold the unitary injection molded structure to the circuit board, wherein the holding member engages the top major surface of the circuit board and extends through a hole in the circuit board and engages the unitary injection molded structure thereby fixing the unitary injection molded structure to the bottom major surface of the circuit board.

15. The method of claim 14, wherein the holding member has a barb.

16. The method of claim 14, wherein the holding member is not an adhesive and is not held in place by an adhesive.

17. A method comprising:
using an injection molded structure to hold an end of a fiber optic ribbon cable such that an axis of a fiber of the fiber optic ribbon cable is parallel to a bottom major surface of a circuit board; and
using the injection molded structure to receive light into a lens portion of the injection molded structure from a source disposed above a top major surface of the circuit board, and to conduct the light toward a planar light reflecting surface of the injection molded structure such that the light reflects off the planar light reflecting surface and is redirected approximately ninety degrees and passes into the end of the fiber optic ribbon cable, wherein the lens portion has a lens axis that is perpendicular to the bottom major surface of the circuit board and wherein the lens portion is disposed in a hole in the circuit board.

18. The method of claim 17, further comprising:
using an adhesiveless attachment mechanism to secure the injection molded structure to the circuit board.

19. An apparatus, comprising:
a lens portion; and
means for holding a fiber optic ribbon cable below a bottom major planar surface of a circuit board and for holding the lens portion in a hole in the circuit board such that a center axis of an optical fiber of the fiber optic ribbon cable extends in a direction parallel to a bottom major planar surface of the circuit board and such that a lens axis of the lens portion extends in a direction perpendicular to the bottom major planar surface of the circuit board, wherein the means is also for providing a substantially planar light reflecting surface that redirects light passing between the optical fiber and the lens portion by approximately ninety degrees, and wherein the means and the lens portion are parts of a single piece of injection molded material.

20. The apparatus of claim 19, wherein the means includes a fiber optic ribbon retaining portion and a light reflecting portion, wherein the fiber optic ribbon retaining portion is adapted to hold and engage the fiber optic ribbon cable, and wherein the substantially planar light reflecting surface is a surface of the light reflecting portion.
